(19) United States
(12) Patent Application Publication
(10) Pub. No.: US 2003/0034238 A1
(43) Pub. Date: Feb. 20, 2003

(54) Multi-position selector switch

(76) Inventor: Chi Hing Leung, Hong Kong (HK)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/201,650

(22) Filed: Jul. 22, 2002

(30) Foreign Application Priority Data
Jul. 23, 2001 (EP) 01401968.1

(51) Int. Cl. H01H 25/04

(52) U.S. Cl. 200/6 A

(57) ABSTRACT

A selector switch (10) for selecting or manipulating at least one function of a consumer product. The selector comprises an operating element having at least one operating area. The selector switch (10) comprises two momentary action switches (22,24;26,28;30,32;34,36) underneath the operating area to control the desired function.

### CROSS REFERENCE TO RELATED APPLICATIONS

This application claims benefit under 35 U.S.C. § 120 from EP application EP 0 140 1968.1

### FIELD OF THE INVENTION

This invention relates to a multi-position push-button selector switch for selecting or manipulating at least one function of a consumer product.

### BACKGROUND OF THE INVENTION

In a selector switch such as described above, the operating element may be designed with a push-button switch or with a joystick, with a single key or momentary switch arranged underneath at least one area. Due to a component defect or operating errors the design may lead to mistriggering.

Generally, a given function is controlled by a single key or momentary switch. For instance, in U.S. Pat. No. 5,902,972, a first switch triggers a first function (window down), a second switch triggers a second function (window up), whereas pressing both switches triggers a third function (automatic). Similarly, U.S. Pat. No. 5,796,056 relates to a multi-stage switch which is specifically designed so that an increasing force leads to a successive operation of different switch elements. U.S. Pat. Nos. 4,975,547 and 6,069,327 describe an arrangement of switches in combination with a multi-position switch where various functions are controlled depending on the combination of the various switch elements.

Recent consumer electronic products, such as video recorders, monitors and the like have, for example, used a four or a multi-position push-button switch comprising a round button or cover for either selecting or navigating a required function. In order to have a uniform feel for the button itself, these buttons are designed so that the exemplary four switches are incorporated in a single piece.

As the button is a single piece, and the functions are controlled by a single key stroke or momentary switch action, there is a possibility of accidentally triggering an adjacent function. The switches can be positionally located in quadrants, North, South, East and West positions. If a user wishes to select any one position, the users finger must press that particular position. If the user presses the plastic button between two switch locations, a detecting unit cannot detect the operation, or detects an unintended operation

### SUMMARY OF THE INVENTION

To avoid mistriggering caused by operating errors, a selector switch comprises two switches located underneath the operating area of the operating element to provide selectable control of the desired function.

Compared to previous selector switches, each selectable function is advantageously controlled by two switches. Only when both switches belonging to the same operating area are activated, only then is the keystroke or button push recognized, otherwise the keystroke will be ignored.

According to a preferred embodiment of the invention, the operating element comprises a single piece push-button, having several adjacent operating areas or segments with at least two switches positionally located underneath each operating area to provide selectable control of desired functions. Advantageously, if a user operates the push-button between two adjacent operating areas, then only one switch of the pair located under each operating area is pressed and activated. An advantageous detector is arranged such that a single switch activation will be ignored. Similarly the detecting circuit is arranged to ignore switch activation of multiple single switches. Furthermore activation of more than one pair of switches is also ignored.

In accordance with the invention, two switches are located underneath the same operating area and are connected in series. Preferably a first end of the series connection is coupled to a first reference potential such as a ground and a second end is coupled to an input from the detecting circuit and to a second reference potential such as a operating voltage via a resistor. The detecting circuit is designed in such a way that only when the two switches are turned on at the same time the detecting circuit can detect that button is being pressed by the user.

To select or navigate four exemplary functions A, B, C, D operating areas or sectors with associated switches are located with reference to compass positions North, South, East and West.

In another embodiment of the invention the two key switches are arranged opposing each other referred to a center line which corresponds to the operating area.

Advantageously the push-button is formed as a single-piece button with circular, rectangular or annular shape.

### BRIEF DESCRIPTION OF THE DRAWINGS

FIG. 1 shows a top plan view of a four-position selector switch push-button cover used in an inventive arrangement.

FIG. 2 shows an inventive arrangement a four-position switch without push-button cover of FIG. 1.

FIG. 3 shows a schematic drawing of an inventive detecting unit forming part of the inventive arrangement of FIGS. 1 and 2.

FIG. 4 shows a perspective view of switching elements of the four-position switch on a motherboard forming part of the inventive arrangement of FIGS. 1 and 2.

### DETAILED DESCRIPTION

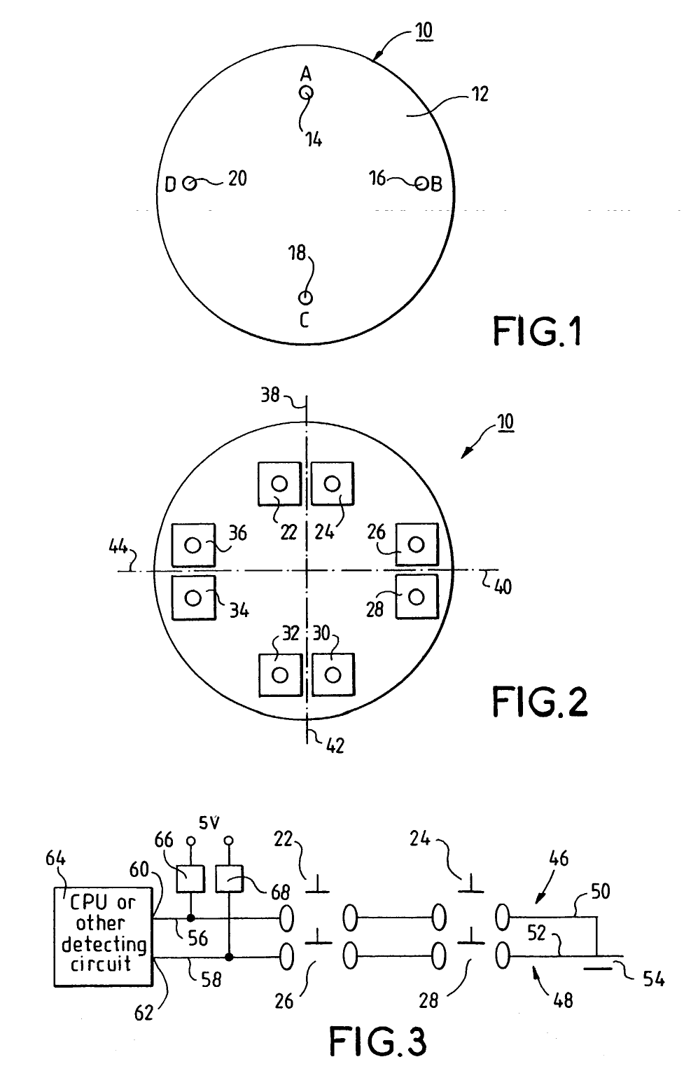

FIG. 1 shows a top plan view of the selector switch 10 designed as a four-position push-button selector switch as specified by the invention, including an operating element formed as a single-piece, round push-button 12. Operating areas 14, 16, 18, 20 are disposed with compass positions North, South, East and West to enable selection of individual functions A, B, C or D of an electronic device such as a video recorder, a monitor or similar device.

FIG. 2 shows a top plan view of the four-position switch 10 without push-button 12. The four-position switch is designed in such a manner, that under each of the operating areas 14, 16, 18, 20 at least two, individual key or momentary action switches 22, 24; 26, 28; 30, 32; and 34, 36 are arranged, to prevent mistriggering. In the preferred embodiment the individual switches are each in a symmetrical arrangement about respective center lines 38, 40, 42, 44 of the operating segments.

FIG. 3 is a simplified schematic drawing of a detector circuit for the selector switch 10 as shown in FIG. 2. This circuit arrangement shows key switches 22, 24; 26, 28. A similar arrangement can be provided for switches 30, 32 and 34, 36. The individual switches are grouped in pairs, for example 22/24 and 26/28, 30/32 and 34/36 with the individual switch pair connected in series and assigned respectively to operating areas 14, 16, 18, 20. As an example, FIG. 3 shows a serial circuit 46 of the key switches 22, 24 as well as a serial circuit 48 of the key switches 26, 28. The serial circuits are each connected to a first end 50, 52 with ground potential 54 and to a second end 56, 58 each with an input 60, 62 of an detecting unit 64, which in the current example is provided as a microprocessor. The inputs 60, 62 are connected through respective resistors 66, 68 to an operating voltage (5V). When, for example, switches 22, 24 are activated concurrently the operating voltage provided to input 60 of microprocessor 64 via exemplary resistor 66 is replaced by ground potential 54. Thus in response to exemplary input 60 assuming a ground potential microprocessor 64 controls activation of the user desired mode.

The inventive detector 64 for the four-position switch 10 is characterized in that at the inputs 60 and 62 of the detecting unit 64, a signal is only present if both the key switches 22, 24 under the operating segment 14 are pushed, i.e. are closed at the same time. If only one key switch is closed, an input signal is not recognized by detector 64.

If the push-button 12 is moved to the provided operating areas 14, 16, 18, 20, the key switches arranged under each of the operating areas react so that a corresponding input signal is generated. If the operating button is pushed, for example, at a spot between North and East, closing individual key switches 24 and 26 of adjacent switch pairs, the detecting unit 64 receives no input signal. Thus, mistriggering is ruled out.

In other words the detecting unit 64 only reacts if the key switches integral to one operating position are pressed together. In this way detector 64 ensures that control activation occurs when the switches of only one operating position are pressed together otherwise the action of pressing of the push-button 12 is ignored.

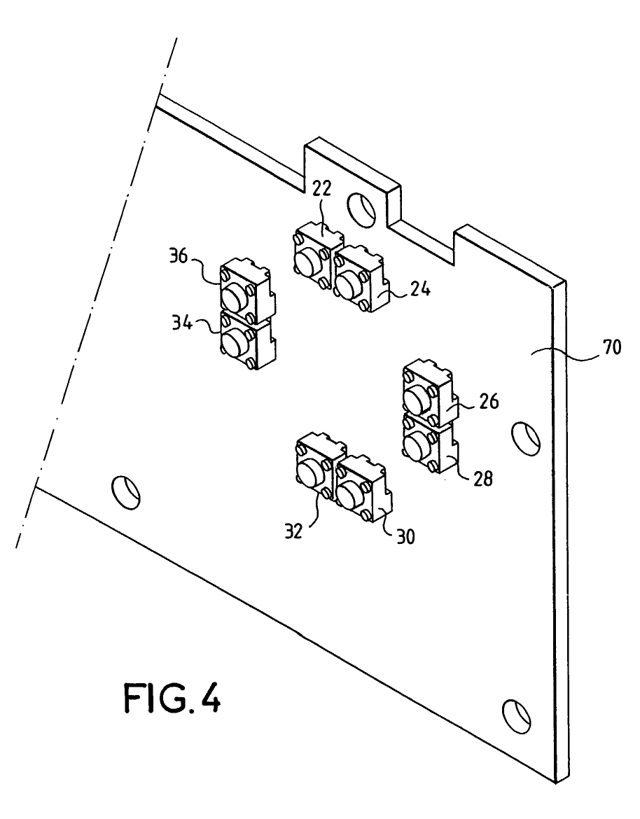

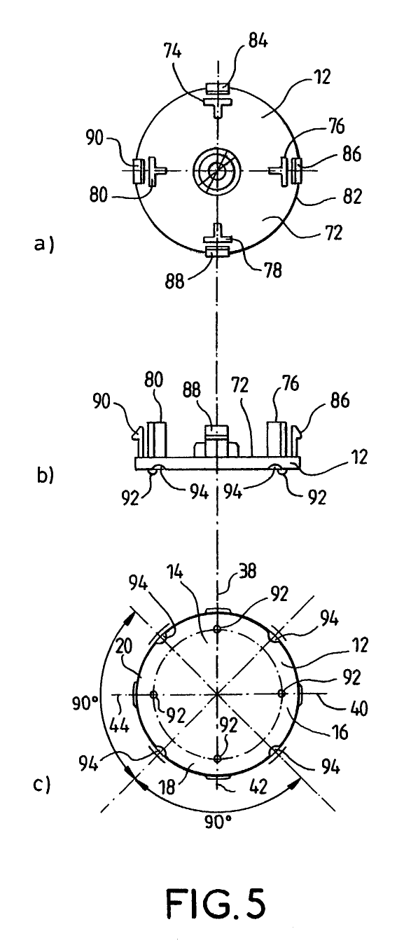

FIG. 4 shows a perspective view of a motherboard 70, on which the key switches 22, 24; 26, 28; 30, 32 as well as 34, 36 are arranged as specified by the invention. The individual key switches 22, 24 can also be designed in one piece as so-called dual-switch.

FIG. 5 shows various views of the push-button 12. The single-piece button 12 in a round design in the current example, can be made of metal or plastic.

FIG. 5a shows an underside 72 of the button 12. Operating elements 74-80 allocated to the key switches 22, 24; 26, 28; 30, 32 as well as 34, 36, extend downwards substantially vertically to operate the key switches. Along the circumferential edge 82 of the push-button 12 locking elements 84-90 also extend downwards from the underside 72 which are provided to hold the push-button 12 in a housing of an electronic device (not shown). FIG. 5b shows a side view of the push-button 12, in which the locking elements 84-90 are visible.

FIG. 5c shows a top plan view of the push-button 12 and the operating segments 14, 16, 18, 20. Here the operating areas 14, 16, 18, 20 are optically separated by the reference numbers 92, 94, the reference number 92, for example is designed as a protrusion and the reference number 94 as an indent, to optically distinguish the operating areas 14, 16, 18, 20 from each other.

The inventive selector switch, described in the current example as four-position push-button selector switch, can of course also be designed as a multi-position switch. The advantageous use of at least two key switches positioned under one operating area, eliminates errors caused by inaccurate or mis-located button pressing. In addition this embodiment provides a simple and low-cost arrangement since no specialized electronic and mechanical elements are required.

What is claimed is:

1. A push-button selector for selecting or manipulating at least one function of a consumer product, comprising:
an operating element having at least one operating area, positioned for operable contact with at least one pair of push-button switches located under said operating area to generate a control signal when said at least one operating area is depressed towards said at least one pair of push-button switches.

2. The selector according to claim 1, wherein said operating element is formed as a single piece push-button, having several adjacent operating areas with at least one pair of push-button switches symmetrically located one with the other under a center of each said operating area to generate respective control signals when one of said several operating areas are depressed towards said at least one pair of push-button switches.

3. The selector according to claim 2, wherein said at least one pair of push-button switches located under each said operating area are connected in series.

4. The selector according to claim 3, wherein a first end of said series connection is coupled to a first reference potential and a second end is coupled to an input of a detecting circuit and to a second reference potential via a resistor.

5. The selector according to claim 1, wherein said at least one pair of push-button switches are connected in series.

6. The selector according to claim 5, wherein a first end of the series connection is coupled to a first reference potential such as a ground and a second end is coupled to an input from a detecting circuit and to a second reference potential such as a operating voltage via a resistor.

7. The selector according to claim 1, wherein said operating element has four operating areas symmetrically disposed with a North, South, East West and North compass arrangement, and each operating area having a respective pair of push-button switches.

8. The selector according to claim 1, wherein said pair of push-button switches are located opposite each other and symmetrically disposed to a center line of said operating area.

9. The selector according to claim 1, wherein said push-button selector is formed as a single-piece with a circular shape.

10. A selector according to claim 1, wherein said push-button selector is formed as a single piece with a rectangular shape.

11. A selector according to claim 1, wherein said push-button selector is formed as a single-piece with an annular shape

12. A selector according to claim 1, wherein said at least one pair of push-button switches are symmetrically positioned one with the other under a center of said at least one operating area.

13. A method for selecting multiple control modes in a consumer product with a single selector button, said method comprising the steps of:
pushing a first segment area of said single selector button;
contacting a pair of push switches with said single selector button upon pushing said first segment area;
selecting a first control mode in accordance with contacting and activating said pair of push switches; and,
selecting other ones of said multiple control modes by pushing other segment areas of said single selector button.

14. The method of claim 13, said method comprising the steps of:
requiring concurrent activation of each one of said pair of push button switches for preventing control mode selection when pushing said single selector button between adjacent segment areas.

15. A method for selecting multiple control modes in a consumer product, comprising the steps of:
selecting a first control mode responsive to sensing a first movement of a selector button at both of a first pair of closely spaced locations;
selecting no control modes responsive to sensing said movement of said selector button at only one of said first pair of closely spaced locations.

16. The method of claim 15, comprising the step of:
concurrently sensing said first movement of said selector button at both of said first pair of closely spaced locations.

17. The method of claim 15, comprising the step of:
selecting a second control mode responsive to sensing a second movement of said selector button at both of a second pair of closely spaced locations.

18. The method of claim 17, comprising the step of:
selecting no control modes responsive to sensing said second movement of said selector button at only one of said second pair of closely spaced locations.

19. The method of claim 17, comprising the step of:
selecting no control modes responsive to sensing said first and second movement of said selector button at only one of each said pair of first and second closely spaced locations.

20. The method of claim 18, comprising the step of:
selecting no control modes responsive to sensing said first and second movement of said selector button at both of each said pair of first and second closely spaced locations.
